(19) United States
(12) Patent Application Publication
(10) Pub. No.: US 2022/0152725 A1
(43) Pub. Date: May 19, 2022

(54) METHOD FOR EVALUATING RESISTANCE WELDING QUALITY OF BATTERY BY USING EDDY CURRENT SIGNAL CHARACTERISTICS

(71) Applicant: LG ENERGY SOLUTION, LTD., Seoul (KR)

(72) Inventors: Sang Hyun KOO, Daejeon (KR); Seok Jin KIM, Daejeon (KR); Su Taek JUNG, Daejeon (KR); Jung Hoon LEE, Daejeon (KR)

(73) Assignee: LG ENERGY SOLUTION, LTD., Seoul (KR)

(21) Appl. No.: 17/440,397

(22) PCT Filed: Jul. 30, 2020
(86) PCT No.: PCT/KR2020/010048

§ 371 Date: Sep. 17, 2021

(30) Foreign Application Priority Data
Jul. 30, 2019 (KR) 10-2019-0092629

(51) Int. Cl. B23K 11/11; G01N 27/90; B23K 11/00; B23K 11/25; B23K 11/18

(52) U.S. Cl. CPC B23K 11/11; G01N 27/9046; B23K 2101/36; B23K 11/257; B23K 11/185; B23K 11/002

(57) ABSTRACT

The present technology relates to a method for evaluating resistance welding quality of a battery by using eddy current signal characteristics, wherein high reliability can be provided by preventing an error caused by a variation according to differences in physical properties of individual batteries, and an evaluation process is simple and clear by applying a non-destructive method.

### TECHNICAL FIELD

This application claims the benefit of priority based on Korean Patent Application No. 10-2019-0092629, filed on Jul. 30, 2019, and the entire contents of the Korean patent application are incorporated herein by reference.

The present invention relates to a method of evaluating the resistance welding quality of a battery, and more particularly, to a method of evaluating the resistance welding quality of a battery using eddy current signal characteristics.

### BACKGROUND ART

As the price of energy sources increases due to the depletion of fossil fuels, and interest in environmental pollution is amplified, the demand for eco-friendly alternative energy sources is increasing. In particular, conventional automobiles using fossil fuels emit pollutants, which act as a major cause of environmental pollution.

Recently, secondary batteries capable of charging and discharging have been widely used as energy sources of wireless mobile devices. In addition, the secondary battery has attracted attention as a power source of an electric vehicle (EV), a hybrid electric vehicle (HEV), etc., which are proposed as a solution for air pollution of existing gasoline vehicles and diesel vehicles using fossil fuel.

As the demand for secondary batteries increases, the importance of evaluating the quality of batteries before the product is released is also increasing. In particular, in the case of a battery in which a battery tab is formed by welding, the defective rate at the welding portion is relatively high. For example, a cylindrical battery has a structure in which a battery cell is wrapped with a metal case, and a battery tab is formed at one end of the cylindrical structure by resistance welding. However, individual physical properties of the metal case or changes in physical properties caused during the welding process cause errors in the evaluation of the battery quality and deteriorate the reliability of the evaluation.

Therefore, there is a high need for a reliable quality evaluation method capable of preventing errors due to differences in physical properties for each metal case while the evaluation process is simple.

### DISCLOSURE

### Technical Problem

The present invention has been invented to solve the above problems, and an object of the present invention is to provide a method of evaluating the quality of resistance welding of a battery using eddy current signal characteristics.

### Technical Solution

A method of evaluating a resistance welding quality for a battery including a resistance-welded welding portion according to the present invention includes:

measuring an eddy current signal along a line connecting an opposite end via a welding portion at one end of one plane including the welding portion, on the plane;

analyzing the measured eddy current signal; and

determining a resistance welding quality by comparing an eddy current signal value at the welding portion with an eddy current signal value at a point other than the welding portion.

According to an embodiment of the present invention, the welding portion is a point where a battery tab is joined by resistance welding. According to a specific embodiment of the present invention, a battery to be evaluated is a cylindrical battery, and the measuring the eddy current signal is performed on a plane of one end of the cylindrical battery to which the battery tab is welded.

According to an embodiment of the present invention, the measuring the eddy current signal is performed on one plane where the battery tab is welded, and a line connecting an opposite end through the welding portion at one end of the plane is a straight line passing through the welding portion or a curved line in which both sides are symmetrical with respect to the welding portion.

According to an embodiment of the present invention, the measuring the eddy current signal is performed continuously or intermittently along a line connecting an opposite end via the welding portion at one end of the plane. Specifically, in the measuring the eddy current signal, both ends of the plane and the welding portion are included as a point to measure the eddy current signal.

According to an embodiment of the present invention, a peak value of the eddy current signal measured at a point other than the welding portion is set as a reference value, a minimum value of the eddy current signal measured at the welding portion is set as a physical property value, and the determining the resistance welding quality includes calculating a difference between a reference value and the physical property value, and determining the resistance welding as being defective when the calculated value is outside a preset range.

Specifically, a battery to be evaluated is a cylindrical battery, and a reference value is an average value of respective peak values of the eddy current signal measured near both ends.

In the present invention, the cylindrical battery includes a case formed of aluminum or an alloy thereof.

According to an embodiment of the present invention, the battery is a cylindrical battery, and the measuring the eddy current signal is performed on a plane of one end where a battery tab has been welded in a cylindrical battery, and includes: a first measuring step of being performed on a first line passing through the welding portion; and a second measurement step of being performed on a second line that intersects the first line at the welding portion and does not overlap with the first line.

### Advantageous Effects

According to the method for evaluating the resistance welding quality of a battery according to the present invention, it is possible to provide high reliability by preventing errors due to differences in physical properties of each individual battery, and an evaluation process is simple by applying a non-destructive method.

### BRIEF DESCRIPTION OF THE DRAWINGS

FIG. 1 is a photograph of a process of performing a method for evaluating the quality of resistance welding of a battery according to an embodiment of the present invention.

FIGS. 2 to 4 show results obtained by observing a cross section of a welding portion for each sample with an electron microscope after forming a battery tab by varying the welding strength at one end of each cylindrical battery.

FIG. 5 is a graph showing results of measuring eddy current signals for batteries in a state before attaching a battery tab.

FIGS. 6 and 7 are graphs showing results of measuring an eddy current signal of a battery by a method according to an embodiment of the present invention, respectively.

FIG. 8 is a graph showing a result of calculating a difference between a reference value and a physical property value for each battery sample.

FIG. 9 is a graph showing measurement results of physical properties for each battery sample.

### DETAILED DESCRIPTION OF THE PREFERRED EMBODIMENTS

The terms and words used in the present specification and claims should not be construed as limited to ordinary or dictionary terms and the inventor may properly define the concept of the terms in order to best describe its invention. The terms and words should be construed as meaning and concept consistent with the technical idea of the present invention.

In the present invention, “welding” refers to a process of bonding two solid metals by applying heat and/or pressure to the two solid metals. In the present invention, “resistance welding” refers to a method of welding a welding portion using resistance heat generated from the metal itself by applying current and pressure to the welding portion, among various welding methods.

In the present invention, “eddy current” is a current in the form of a vortex generated in a conductor by electromagnetic induction when the magnetic field applied to the conductor changes over time. In addition, in the present invention, the “eddy current signal” refers to a signal according to a non-destructive testing method that generates eddy current in the tested part of a subject of inspection by passing high-frequency current through an excitation coil, and detects changes in the distribution state of eddy current due to defects.

The process of measuring the eddy current signal can be performed by a commonly known method. A brief description of the measurement principle is as follows. Assuming that the DC resistance, inductance, and frequency of the coil at the time of the air core are R0, L0, and ω, the impedance Z of the coil becomes as follows: Z=R₀+jωL₀. When the excitation coil approaches the subject, the impedance of the excitation coil changes according to the magnetic permeability and conductivity of the subject. Since the impedance of the excitation coil can be normalized based on the reactance ωL₀ at the air core and expressed on the impedance plane as R/ωL₀ and ωL/ωL₀, the defect distribution state can be obtained from this impedance diagram. The process of measuring the eddy current signal can be performed using commercially available measurement equipment. For example, JAS-0100W of Jeongan Systems Co., Ltd. can be used.

The present invention provides a quality evaluation method for evaluating the quality of resistance welding for a battery including a resistance-welded welding portion.

The method of evaluating resistance welding quality of a battery according to the present invention includes:

a step of measuring an eddy current signal along a line connecting an opposite end via a welding portion at one end of one plane including the welding portion, on the plane; and

a step of analyzing the measured eddy current signal and determining a resistance welding quality by comparing an eddy current signal value at the welding portion with an eddy current signal value at a point other than the welding portion.

The evaluation method according to the present invention is differentiated from a method of measuring a signal value of a welding portion and simply comparing it with a preset reference value. In battery manufacturing, even if the same manufacturing process and battery case of the same material are applied, there is a difference in physical properties between individual battery cases. In addition, when welding is applied to the battery case, this causes a change in physical properties of the battery case. In particular, resistance welding generates resistance heat during the welding process and exhibits various thermal behaviors in individual welding processes. The difference in physical properties of the battery case and the thermal insulation during welding act as errors in the quality evaluation process. In the present invention, in the step of measuring the eddy current signal, the welding portion and the portion spaced apart from the welding portion are evaluated together. In the present invention, in the step of measuring the eddy current signal, the physical properties of the welding portion and the portion spaced apart from the welding portion are measured together, and the welding quality is evaluated from the difference between them. Therefore, the evaluation method according to the present invention has an effect of preventing errors due to such errors.

In one example, the welding portion is a point at which a battery tab is joined by resistance welding. The evaluation method according to the present invention can be applied as a method of evaluating the welding quality of a battery tab portion welded through a resistance welding process. For example, in the case of a cylindrical battery, a battery tab is formed in the central portion of one side cross section of the cylindrical battery case. Such a battery tab can be formed through a resistance welding process. Therefore, the evaluation method according to the present invention can be utilized as a method of evaluating the welding quality of a battery tab in a cylindrical battery.

In one example, the step of measuring the eddy current signal is performed on one plane to which the battery tab is welded. In addition, a line connecting the opposite end through the welding portion at one end of the plane is a straight line passing through the welding portion or a curved line in which both sides are symmetrical with respect to the welding portion. In this case, the step of measuring the eddy current signal may be performed along a straight line across the welding portion, or along a straight line or a curved line symmetrical with respect to the welding portion. This process is to continuously detect physical properties from one end to the opposite end through the welding portion on one plane of the battery.

As a specific example of the present invention, the battery to be evaluated is a cylindrical battery. In this case, the step of measuring the eddy current signal is performed on the plane of one end of the cylindrical battery to which the battery tab is welded. The cylindrical battery has a cylindrical body, and electrode tabs of a positive electrode or a negative electrode are formed at the centers of both ends of the cylindrical shape, respectively. In the present invention, when the battery to be evaluated is a cylindrical battery, the eddy current signal is measured on the plane of one end where the battery tab is welded.

For example, the step of measuring the eddy current signal may be performed continuously or intermittently along a line connecting the opposite end via the welding portion at one end of the plane. In the present invention, measuring the eddy current “continuously” means continuously measuring the eddy current without a separation distance between measurement points. In addition, measuring the eddy current “intermittently” means measuring the eddy current along a predetermined line with a spaced distance between measurement points.

In the step of measuring the eddy current signal, it is preferable to include both ends of the plane and a welding portion as a point for measuring the eddy current signal. In the case where the step of measuring the eddy current signal can be performed intermittently, one end as the starting point of the measurement, the welding portion as the center point, and the opposite end as the end point of the measurement are essential measurement points.

Specifically, in the method for evaluating the quality of resistance welding of a battery according to the present invention, the peak value of the eddy current signal measured at a point other than the welding portion is used as a reference value, and the minimum value of the eddy current signal measured at the welding portion is used as the physical property value. In addition, in the step of determining the resistance welding quality, a difference between the measured reference value and the physical property value is calculated, and based on this, whether or not the welding portion is defective is determined. If the difference between the calculated reference value and the physical property value is outside the preset range, it is determined as defective.

In one example, the battery to be evaluated of the present invention is a cylindrical battery, and the reference value is an average value of each peak value of the eddy current signal measured near both ends. In the case of a typical cylindrical battery, the signal at the welding portion becomes a physical property value, and the signal at both ends serves as a reference value. That is, in a cylindrical battery, the eddy current signal at the welding portion shows the lowest value, and the eddy current signal measured near both ends often shows a peak. At this time, the lowest value seen from the welding portion becomes the physical property value, and the average value of the peaks seen from both ends becomes the reference value.

For example, when the battery to be evaluated is a cylindrical battery, the cylindrical battery may have a structure having a case formed of aluminum or an alloy thereof. In this case, a battery tab made of the same material may be welded to a cylindrical case body made of aluminum or an alloy thereof. Or it includes the case where the battery tab is plated with nickel or an alloy thereof.

Further, in another example, a battery to be evaluated is a cylindrical battery, and the step of measuring the eddy current signal is performed on a plane of one end where a battery tab has been welded in a cylindrical battery, and includes: a first measuring step of being performed on a first line passing through the welding portion; and a second measurement step of being performed on a second line that intersects the first line at the welding portion and does not overlap with the first line. In this case, the eddy current signal is measured along two lines, and it is to increase the reliability of the evaluation through cross measurement. In the above example, the step of measuring the eddy current signal along the first and second lines is performed, but the present invention does not exclude the case of measuring the eddy current signal along two or more lines.

Hereinafter, specific examples of the present invention will be described in detail with reference to the accompanying embodiments and drawings. Accordingly, the embodiments described in the specification and the configurations described in the drawings are only the most preferred embodiments of the present invention, and do not represent all of the technical ideas of the present invention. It is to be understood that there may be various equivalents and variations in place of them at the time of filing the present application.

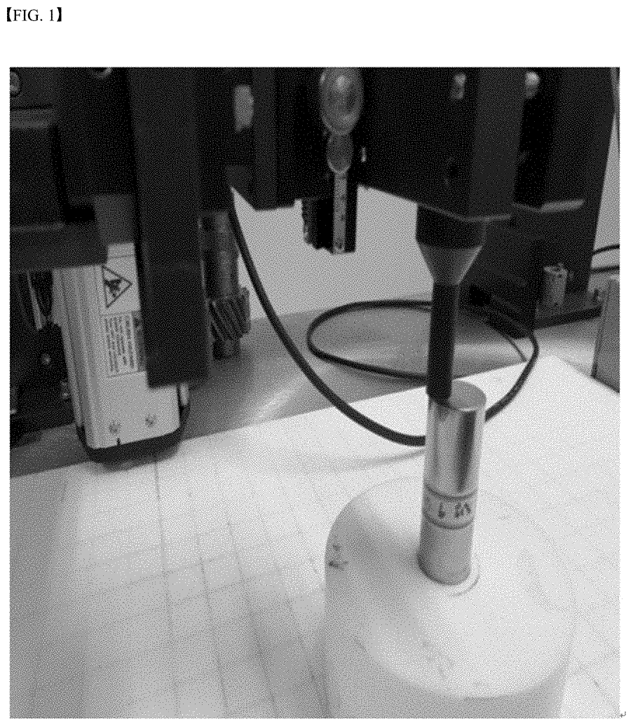

In this regard, FIG. 1 is a photograph of a process of performing a method for evaluating the quality of resistance welding of a battery according to an embodiment of the present invention. The battery to be evaluated is a cylindrical battery. With the cylindrical battery standing upright on the measuring table, the eddy current signal is measured for one end surface of the battery. Eddy current signal measurement is performed from one end of the upper end surface to the opposite end through the center.

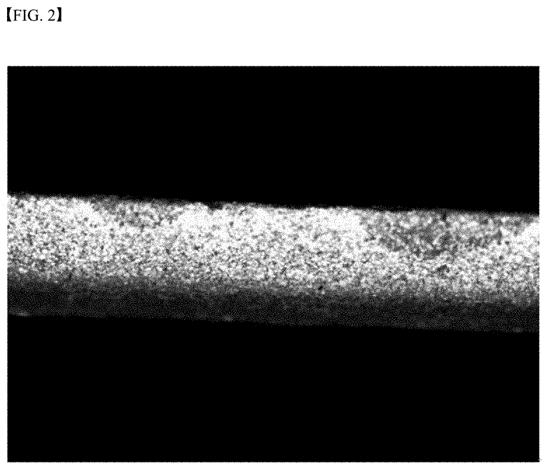

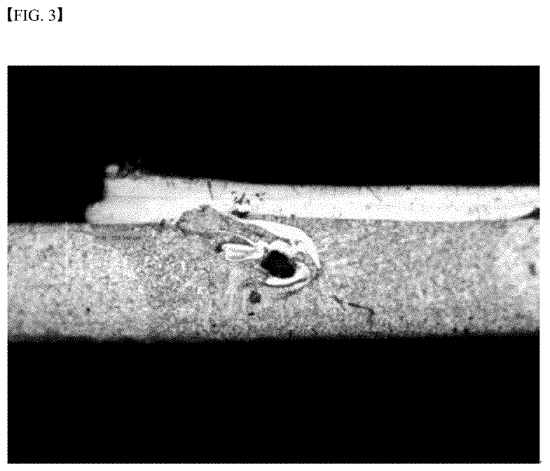

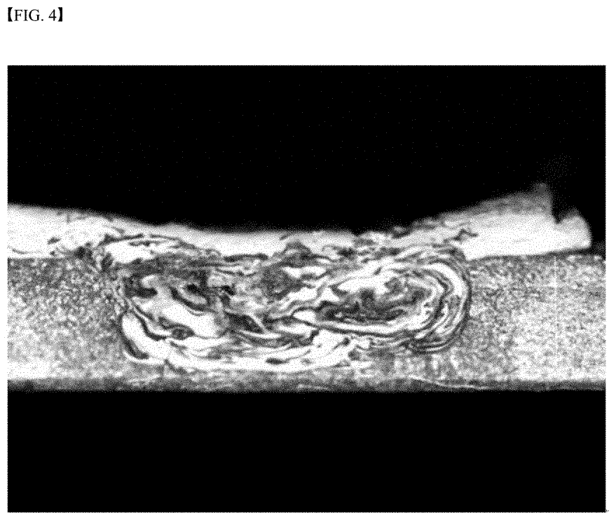

FIGS. 2 to 4 are results of welding battery tabs with different welding strengths, and observing a cross section of each welded sample with an electron microscope. FIG. 2 shows a case where the welding strength is weak, and a change in physical properties is hardly observed around the welding portion. On the other hand, FIG. 3 shows a case where the welding strength is appropriate, and changes in physical properties are observed around the welding portion. FIG. 4 shows a case in which the welding strength is excessive, and it can be seen that the periphery of the welding portion is excessively deformed. In this case, the cases of FIGS. 2 and 4 should be determined as defective products, and FIG. 3 should be determined as good products. Typically, in the case of welding a battery tab, when the welding strength is weak, a defect occurs in which the battery tab is separated or electrical connection is disconnected during use, and when the welding strength is excessive, process efficiency is degraded. However, in the battery to be evaluated, it is not easy to observe the cross section of the welding portion. Thus, the present invention proposes a method capable of effectively evaluating the quality of a welding portion in a non-destructive manner.

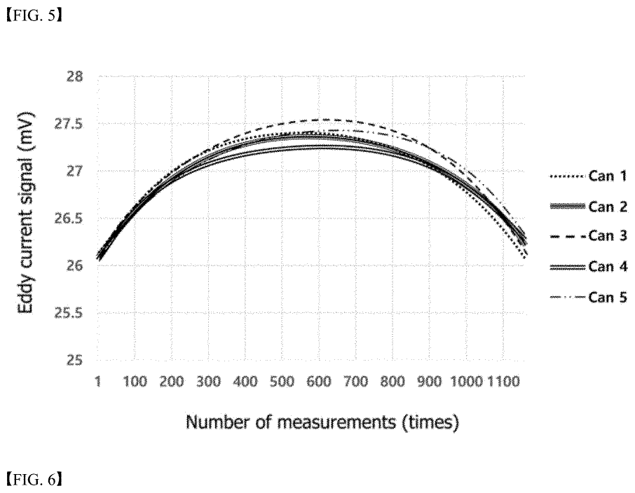

FIG. 5 is a graph showing results of measuring an eddy current signal for batteries that have not undergone a welding process for attaching a battery tab. Specifically, five cylindrical battery samples without a battery tab attached were randomly selected (cans 1 to 5), and an eddy current signal was measured for each battery sample. Referring to FIG. 5, although the selected battery samples were manufactured through the same manufacturing process, it can be seen that there is a data shift due to the difference in physical properties. Such data shift causes a decrease in the reliability of welding quality evaluation.

### Example: Performing Resistance Welding Quality Evaluation for Each Battery Sample

Resistance welding was performed on a cylindrical battery sample having a case made of aluminum to attach a battery tab. At this time, the welding strength was different for each sample. Specifically, in Samples 1 to 3, resistance welding was performed at an appropriate level of welding strength, and in Samples 4 to 6, resistance welding was performed at a weak level of welding strength.

The eddy current signal value was measured for each sample. The eddy current signal value was measured continuously over 1000 times from the outer left area to the right with respect to the side where the battery tab is attached, and was performed using JAS-0100W equipment of Jeongan Systems.

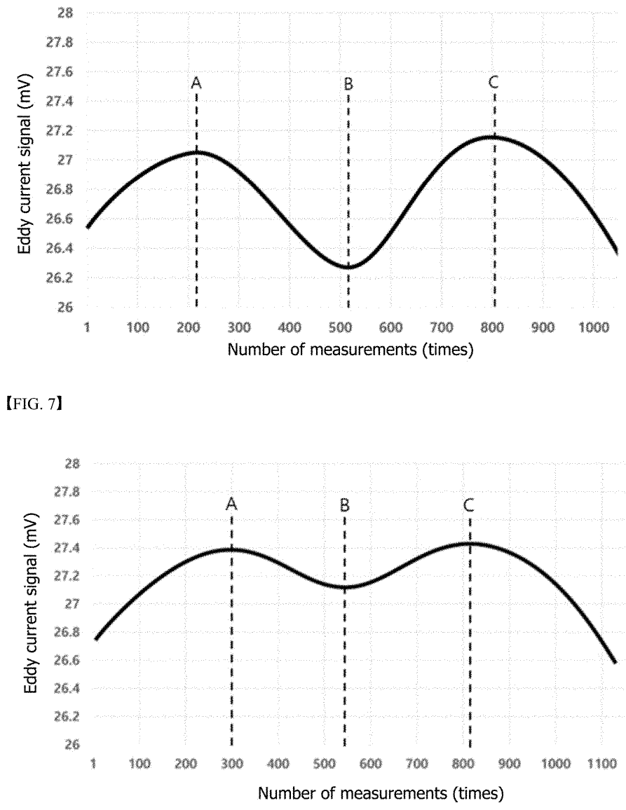

For example, the measurement result of the eddy current signal value for Sample 1 is shown in FIG. 6, and the measurement result of the eddy current signal value for Sample 4 is shown in FIG. 7. In FIGS. 6 and 7, A denotes the left end of the sample, B denotes the center point of the welding portion, and C denotes the right end of the sample. In the graphs showing the measurement results for Samples 1 to 6, it was confirmed that the values at the center were small and the values increased as the center went to the left and right. The measurement results for each sample are summarized in Table 1 below.

In Table 1, the value at the highest point on the left of the graph from the center point (B) is indicated as “left peak value”, the value at the lowest point near the center point (B) is indicated as “minimum value of the welding portion”, and the numerical value at the highest point on the right side of the graph from the center point (B) is indicated as “right peak value”.

It is shown in Table 1. In Table 1 below, the unit is mV.

TABLE 1

| | | Welding portion | |
|---|---|---|---|
| Sample No. | Left peak value | minimum value | Right peak value |
| Sample 1 | 27.3214 | 26.7256 | 27.2289 |
| Sample 2 | 27.2154 | 26.5283 | 27.2696 |
| Sample 3 | 27.3874 | 26.5384 | 27.2382 |
| Sample 4 | 27.1892 | 26.6803 | 26.9762 |
| Sample 5 | 27.3867 | 27.1334 | 27.4335 |
| Sample 6 | 27.3850 | 26.9509 | 27.3482 |

In the results of Table 1 above, the average value of the left and right peak values is calculated and displayed as a reference value, and the minimum value of the welding portion is expressed as a physical property value, as shown in Table 2 below.

TABLE 2

| | | Physical property | |
|---|---|---|---|
| Sample No. | Reference value | value | Difference |
| Sample 1 | 27.2752 | 26.7256 | 0.5496 |
| Sample 2 | 27.2425 | 26.5283 | 0.7142 |
| Sample 3 | 27.3128 | 26.5384 | 0.7744 |
| Sample 4 | 27.0827 | 26.6803 | 0.4024 |
| Sample 5 | 27.4101 | 27.1334 | 0.2767 |
| Sample 6 | 27.3666 | 26.9509 | 0.4157 |

Referring to Table 2, it can be seen that in the case of Samples 1 to 3, the difference between the reference value and the physical property value is 0.5 or more, and in the case of Samples 4 to 6, the difference is less than 0.5. In the present invention, based on the results of Table 2 above, Samples 1 to 3 are determined as normal products, and Samples 4 to 6 are determined as defective products.

However, if only the physical property values, which are the eddy current signal values at the welding part, are compared, it is not easy to determine whether the products are defective. Specifically, the physical property values of Samples 1 to 3 are between 26.5283 and 26.7256. On the other hand, the physical property value of Sample 4 was 26.6803, and the physical property value of Sample 6 was 26.5909. In comparison to the range of Samples 1 to 3, the physical property value of Sample 4 overlaps with the above range, and the physical property value of Sample 6 appears to be similar to the above range.

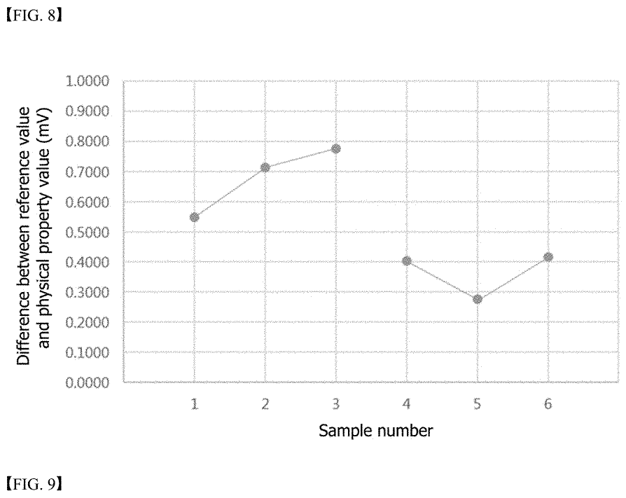

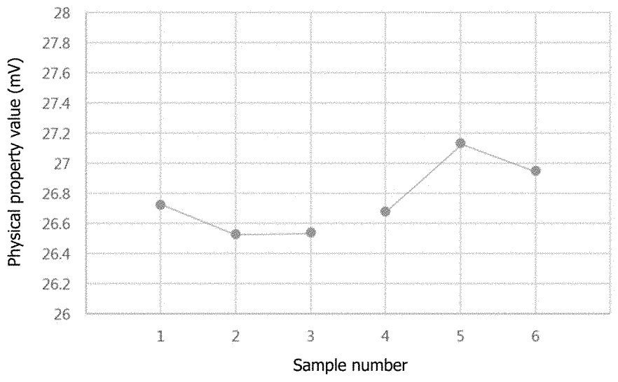

Specifically, FIG. 8 is a graph showing the result of calculating differences between reference values and physical property values for respective samples. In FIG. 8, the values of Samples 1 to 3 and the values of Samples 4 to 6 show a remarkable difference, and through this, it is clear to distinguish between a normal product and a defective product. On the other hand, FIG. 9 is a graph showing the result of measuring physical property values for respective samples. In FIG. 9, compared with Samples 1 to 3, no difference was observed in Sample 4, and Sample 6 showed similar values.

Therefore, it can be seen that if only the physical property values are compared, the determination as to whether the battery is defective or not is not accurate. In the present invention, in the step of measuring an eddy current signal, accurate welding quality is possible by measuring the physical properties of the welding portion and the portion spaced apart from the welding portion, and comparing the differences between them.

1. A method of evaluating a resistance welding quality for a battery including a welding portion, comprising:
measuring an eddy current signal on one plane of the battery including the welding portion at a line from one end of the plane to an opposite end that goes across the welding portion;
analyzing the measured eddy current signal; and
determining a resistance welding quality by comparing an eddy current signal value at the welding portion with an eddy current signal value at a point other than the welding portion.

2. The method of claim 1, wherein the welding portion is a point where a battery tab is joined by resistance welding.

3. The method of claim 1, wherein:
the battery is a cylindrical battery, and
the measuring the eddy current signal is performed on a plane of one end of the cylindrical battery to which the battery tab is welded.

4. The method of claim 1, wherein:
measuring the eddy current signal is performed on one plane where the battery tab is welded, and
a line connecting an opposite end through the welding portion at one end of the plane is a straight line passing through the welding portion or a curved line in which both sides are symmetrical with respect to the welding portion.

5. The method of claim 1, wherein the measuring the eddy current signal is performed continuously or intermittently along a line connecting an opposite end via the welding portion at one end of the plane.

6. The method of claim 5, wherein in the measuring the eddy current signal, both ends of the plane and the welding portion are included as a point to measure the eddy current signal.

7. The method of claim 1, wherein:
a peak value of the eddy current signal measured at a point other than the welding portion is set as a reference value,
a minimum value of the eddy current signal measured at the welding portion is set as a physical property value, and
the determining the resistance welding quality includes calculating a difference between a reference value and the physical property value, and determining the resistance welding as being defective when the calculated value is outside a preset range.

8. The method of claim 1, wherein:
the battery is a cylindrical battery, and
a reference value is an average value of respective peak values of the eddy current signal measured near both ends.

9. The method of claim 8, wherein the cylindrical battery includes a case formed of aluminum or an alloy thereof.

10. The method of claim 1, wherein:
the battery is a cylindrical battery, and
the measuring the eddy current signal is performed on a plane of one end where a battery tab has been welded in a cylindrical battery, and includes:
a first measuring step of being performed on a first line passing through the welding portion; and
a second measurement step of being performed on a second line that intersects the first line at the welding portion and does not overlap with the first line.
